(19) United States
(12) Patent Application Publication
(10) Pub. No.: US 2016/0144601 A1
(43) Pub. Date: May 26, 2016

(54) REINFORCED PLATED POLYMERS

(71) Applicant: UNITED TECHNOLOGIES CORPORATION, Hartford, MA (US)

(72) Inventor: Grant Cook, Spring, TX (US)

(21) Appl. No.: 14/903,296

(22) PCT Filed: Jul. 9, 2014
(86) PCT No.: PCT/US2014/045967

§ 371 Date: Jan. 7, 2016

Related U.S. Application Data
(60) Provisional application No. 61/844,011, filed on Jul. 9, 2013.

(51) Int. Cl. B32B 15/02; C23C 18/31; C23C 18/16; B32B 7/08; B32B 15/08

(52) U.S. Cl. CPC B32B 15/02; B32B 7/08; B32B 15/08; C23C 18/1646; C23C 18/31; B32B 2255/205; B32B 2255/10

(57) ABSTRACT

A metal-plated component includes a non-metallic core having an outer surface, a metal layer covering at least a portion of the outer surface of the non-metallic core, and a reinforcing structure located within the non-metallic core for increasing the structural capacity of the metal-plated component. A method for reinforcing a metal -plated component includes forming a non-metallic core, positioning a reinforcing structure within the non-metallic core, and depositing a metal layer on the non-metallic core.

### CROSS-REFERENCE TO RELATED APPLICATIONS

This application claims priority under 35 U.S.C. § 119(e) to U.S. Provisional Patent Application Ser. No. 61/844,011 filed on Jul. 9, 2013.

### FIELD OF THE DISCLOSURE

This disclosure relates to metal-plated components and methods of reinforcing the same. More specifically, this disclosure relates to metal-plated components including a non-metallic core having a metal layer covering at least a portion of the outer surface of the non-metallic core, and reinforced with structures located within the non-metallic core. The method of reinforcing includes forming a non-metallic core, positioning a reinforcing structure within the non-metallic core, and depositing a metal layer on the surface.

### BACKGROUND

New advances in plating technology have allowed the use of plated polymers and composite materials in applications that have previously required stronger, typically purely metallic or ceramic, materials. However, to achieve high strength, plated polymeric parts tend to require thick plating layers. These thick plating layers add to the cost and weight of the part and can present plating-specific problems such as nodulation and pitting. Nodulation is the excessive build up of metal plating along high-current-density locations of a part. Corners and edges of a plated part tend to receive larger amounts of plating while recesses and holes receive less. Pitting refers to the formation of holes (porosity) in the metal plating due to the presence of impurities in the plating bath. The thicker the plating, the longer the plating process runs and the more pronounced the nodulation and pitting problems typically become. In some cases, thick plating layers are still not enough to accommodate certain severe loads such as those due to fire or impact. These problems have discouraged others from attempting to manufacture plated polymeric parts capable of use within gas-turbine engines.

### SUMMARY OF THE DISCLOSURE

In accordance with one aspect of the present disclosure, a metal-plated component is disclosed. The metal plated component may include a non-metallic core having an outer-surface with a metal layer covering at least a portion of the outer surface of the non-metallic core. In addition, the metal-plated component may have a reinforcing structure located within the non-metallic core for increasing the structural capacity of the metal-plated component.

In a refinement, the non-metallic core may comprise a material selected from the group consisting of polyether ether ketones, polyphenylene sulfides, polyesters, polyamides, polyetherimides, thermoplastic polyimides, polyether ketone ketones, polysulfones, any of the foregoing with fiber reinforcement and combinations thereof

In another refinement, the non-metallic core may comprise a material selected from the group consisting of condensation polyimides, addition polyimides, epoxy cured with aliphatic and/or aromatic amines and/or anhydrides, cyanate esters, phenolics, polyesters, polybenzoxazine, polyurethanes, polyacrylates, polymethacrylates, silicones (thermoset), any of the foregoing with fiber reinforcement and combinations thereof

In another refinement, the non-metallic core may comprise a composite material.

In another refinement, the reinforcing structure may comprise a material selected from the group consisting of metals, alloys, intermetallics, ceramics, carbon-fiber composites, and combinations thereof

In another refinement, the reinforcing structure may be spaced from the metal layer.

In another refinement, the reinforcing structure may be joined to the metal layer.

In another refinement, the reinforcing structure may be joined to the metal layer so that loads are transferred from the metal layer to the reinforcing structure.

In another refinement, the fastener may be selected from the group consisting of bolts, screws, and rivets that joins the reinforcing structure to the metal layer.

In another refinement, the reinforcing structure may comprise a plurality of rods or tubes.

In another refinement, the reinforcing structure may comprise a hollow tube.

In another refinement, the non-metallic core may comprise a plurality of layers, and the reinforcing structure may be positioned between adjacent layers of the non-metallic core.

In another refinement, the reinforcing structure may comprise a mesh.

In accordance with another aspect of the invention, a method for reinforcing a metal-plated component is disclosed. The method may comprise forming a non-metallic core, then positioning a reinforcing structure within the non-metallic core, and depositing a metal layer on the non-metallic core.

In a refinement, the reinforcing structure may be spaced from the metal layer that is deposited on the non-metallic core.

In another refinement, the reinforcing structure may be joined with the metal layer.

In another refinement, the method may further comprise the step of attaching the reinforcing structure to the metal layer with a fastener.

In another refinement, the depositing the metal layer on the non-metallic core may occur after the reinforcing structure is positioned within the non-metallic core.

In another refinement, the method may further comprise the step of masking the reinforcing structure to prevent metal deposition on the reinforcing structure.

In another refinement, the reinforcing structure may be positioned within the non-metallic core after depositing the metal layer on the non-metallic core.

### BRIEF DESCRIPTION OF THE DRAWINGS

FIG. 1A is a cross sectional view of a plated structure having reinforcing rods.

FIG. 1B is a cross sectional view of a plated structure having a reinforcing tube.

FIG. 2 is an exploded perspective view of a non-metallic structure having reinforcing meshes and which is subsequently plated.

FIG. 3 is an interior view of a plated structure having a regularly spaced, three-dimensional reinforcing structure attached to the metal plating.

FIG. 3A is a cross sectional view of an edge of the plated structure of FIG. 3 showing one embodiment of attaching the reinforcing structure to the metal plating.

FIG. 3B is a cross sectional view of an edge of the plated structure of FIG. 3 showing another embodiment of attaching the reinforcing structure to the metal plating.

FIG. 4 is an exploded perspective view of a plated structure having a reinforcing structure.

### DETAILED DESCRIPTION

The terms “plated polymer” and “plated polymeric” part or component as used herein refer to a metal-covered non-metallic material, including, but not limited to, polymers, with or without reinforcing materials, having a metal covering formed by electroplating, electroless plating, electroforming, and other metal deposition methods and composite materials having a metal covering formed by electroplating, electroless plating, electroforming, and other metal deposition methods. “Composite materials” include, but are not limited to, thermoplastic or thermoset resin materials and reinforcing fibers (e.g., glass or carbon).

According to embodiments of the present invention, plated-polymeric parts include a reinforcing structure that increases the load-bearing ability of the parts. By increasing the load-bearing ability of a part with a reinforcing structure, the thickness of the plating around the polymeric (or composite) core can be reduced while still providing the same or similar strengths. Reduction in the thickness of the plating improves the cost and lead time of the part while also reducing the plating-specific problems described above.

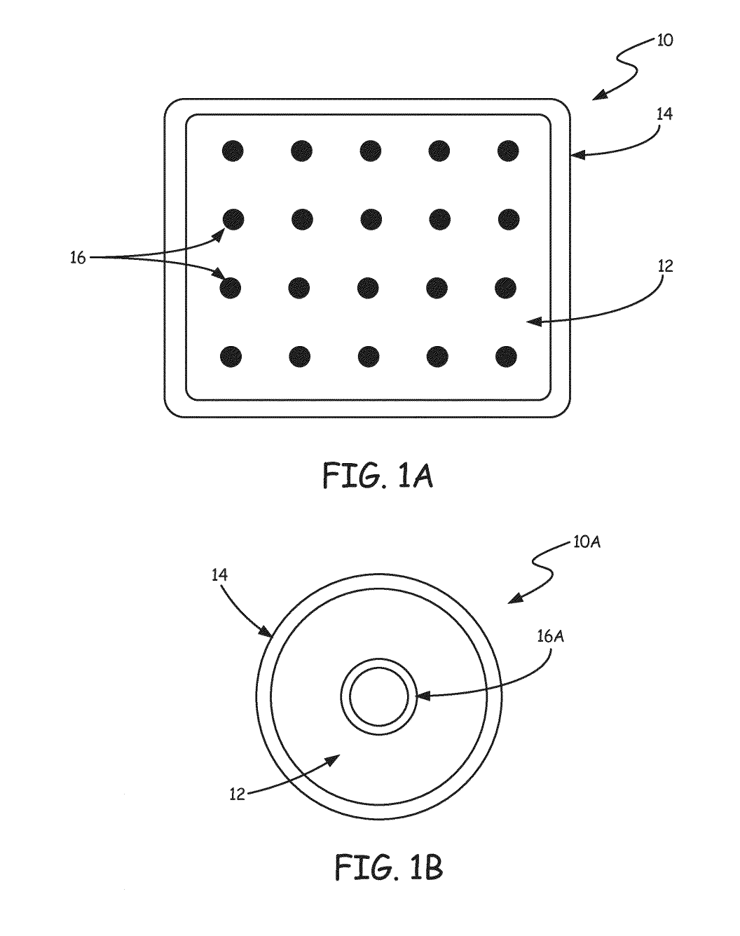

FIG. 1A illustrates one embodiment of a reinforced plated-polymeric component. Reinforced plated-polymeric component 10 includes non-metallic core 12, metal layer 14 and one or more reinforcing structures 16. In some embodiments, non-metallic core 12 is formed from a polymeric material, forming a polymeric component. Suitable thermoplastics for non-metallic core 12 include, but are not limited to, polyether ether ketones, polyphenylene sulfides, polyesters, polyamides, polyetherimides, thermoplastic polyimides, polyether ketone ketones, polysulfones, and combinations thereof, including any of the foregoing with fiber reinforcement. In other embodiments, non-metallic core 12 is formed from a composite material, which can include a thermoplastic or thermoset resin and continuous or long discontinuous fiber reinforcement. Suitable thermoset materials include condensation polyimides, addition polyimides, epoxy cured with aliphatic and/or aromatic amines and/or anhydrides, cyanate esters, phenolics, polyesters, polybenzoxazine, polyurethanes, polyacrylates, polymethacrylates, silicones (thermoset), and combinations thereof. In some embodiments, non-metallic core 12 has an average thickness between about 1.27 mm (0.050 inches) and about 12.7 mm (0.500 inches). Non-metallic core 12 can be formed by injection molding, compression molding, extrusion, thermoforming, transfer molding, composite layup (autoclave, compression, or liquid molding), additive manufacturing (liquid bed, powder bed, deposition processes), and other manufacturing techniques.

Metal layer 14 is formed over at least a portion of non-metallic core 12 and joined to non-metallic core 12. In the embodiment shown in FIG. 1A, metal layer 14 is formed over all of the outer surface of non-metallic core 12. Metal layer 14 can be formed from any metal having a melting temperature above about 150° C. (302° F.). In some embodiments, metal layer 14 contains nickel, cobalt, iron, or alloys of nickel, cobalt and/or iron. Metal layer 14 can be formed on and joined to non-metallic core 12 by electroplating, electroless plating, electroforming, or any other metal deposition method capable of joining metal layer to non-metallic core 12. In some embodiments, metal layer 14 has a thickness between about 0.127 mm (0.005 inches) and about 2.54 mm (0.100 inches).

Reinforced plated-polymeric component 10 includes one or more reinforcing structures 16. Reinforcing structures 16 provide support to plated-polymeric component 10. Reinforcing structures 16 are generally made up of materials having greater structural strength than the constituents of non-metallic core 12. In some embodiments, reinforcing structures 16 are composed of a material selected from the group consisting of metals, alloys, intermetallics, ceramics, carbon-fiber composites, and combinations thereof

Reinforcing structures 16 can take various shapes depending on the overall geometry of plated-polymeric component 10, non-metallic core 12, and/or metal layer 14. In the embodiment shown in FIG. 1A, reinforcing structures 16 are rods spaced throughout non-metallic core 12. Reinforcing rods 16 provide additional support to non-metallic core 12 and plated-polymeric component 10.

Reinforcing structures 16 can be positioned within non-metallic core 12 during molding or following molding. For example, in the embodiment shown in FIG. 1A, reinforcing structures 16 can be arranged as shown in an empty mold. Once reinforcing structures 16 are arranged, non-metallic core 12 can be injection molded around reinforcing structures 16 so that non-metallic core 12 and reinforcing structures 16 form an integral core. Alternatively, non-metallic core 12 can be injection or compression molded, extruded, etc. without reinforcing structures 16. Reinforcing structures 16 can be added to non-metallic core 12 before it cools and hardens. Reinforcing structures 16 can also be added to non-metallic core 12 following hardening. In some cases, material from non-metallic core 12 must be removed in order to insert reinforcing structures 16.

FIG. 1B shows another embodiment of a reinforced plated-polymeric component. Reinforced plated-polymeric component 10A includes hollow tube 16A. Hollow tube 16A provides additional structural support to plated polymer component 10A while also potentially reducing its weight compared to a solid core.

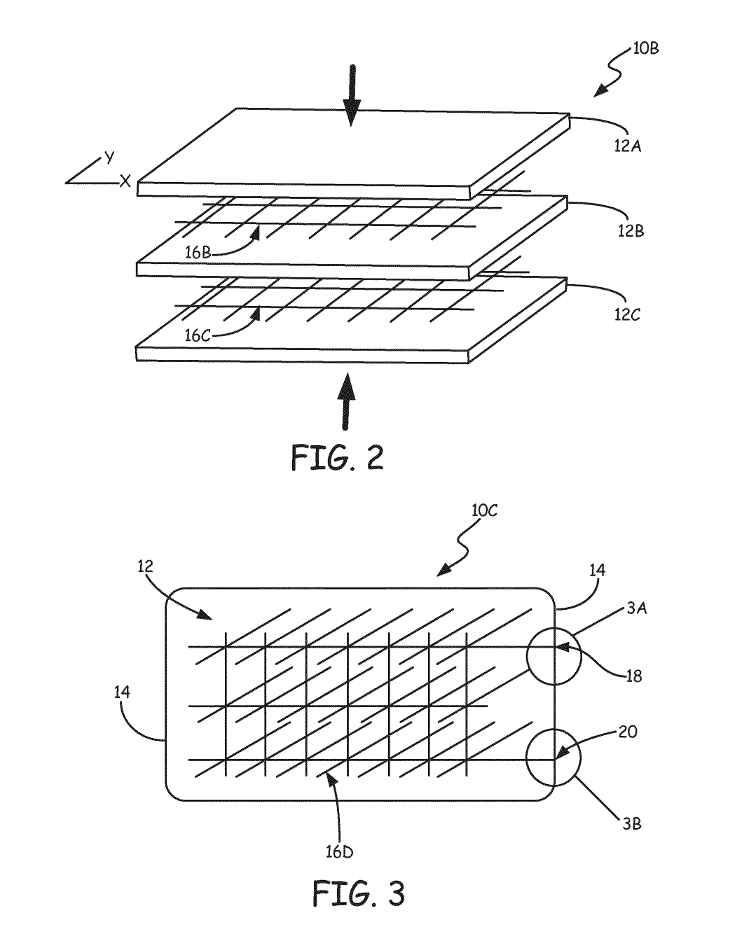

FIG. 2 illustrates an exploded view of another embodiment of a reinforced plated-polymeric component. FIG. 2 shows reinforced plated-polymeric component 10B in which non-metallic core 12 is made up of three separate layers (12A, 12B, and 12C). Layers 12A, 12B, and 12C are pressed together to form non-metallic core 12. A mesh of reinforcing structures 16 are positioned between adjacent layers. Reinforcing mesh 16B is positioned between layers 12A and 12B, and reinforcing mesh 16C is positioned between layers 12B and 12C. Once layers 12A, 12B, and 12C are pressed together to form non-metallic core 12, metal layer 14 (not shown in FIG. 2) can be deposited on non-metallic core 12. Reinforcing meshes 16B and 16C provide additional structural support to plated-polymeric component 10B.

In some embodiments, reinforcing structures 16 are spaced from metal layer 14. That is, reinforcing structures 16 do not come into contact with metal layer 14 and instead reside completely within non-metallic core 12. FIGS. 1A, 1B and 2 illustrate embodiments in which reinforcing structures 16 do not contact metal layer 14. In other embodiments, reinforcing structures 16 contact, and in some cases are joined with, metal layer 14.

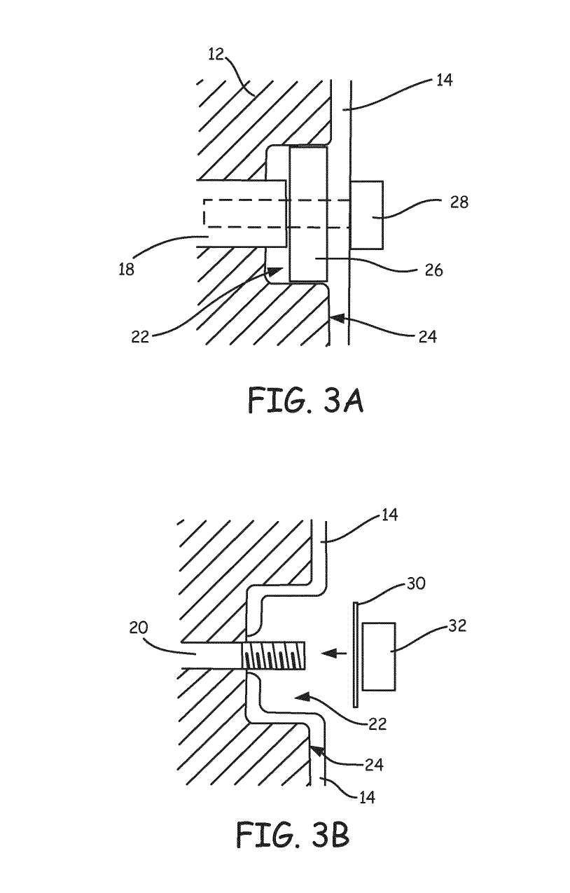

FIG. 3 illustrates reinforced plated-polymeric component 10C having reinforcing structure 16D located within non-metallic core 12. Ends 18 and 20 of reinforcing structure 16D are joined to metal layer 14 to increase the amount of support reinforcing structure 16D provides to plated-polymeric component 10C. Ends 18 and 20 of reinforcing structure 16D can contact and/or join with metal layer 14 in different ways as shown in FIGS. 3A and 3B. FIG. 3A shows the engagement of end 18 with metal layer 14. End 18 of reinforcing structure 16D includes threads for receiving a bolt. End 18 extends through non-metallic core 12 into recess 22. Recess 22 can be a recess, groove, or depression located near outer edge 24 of non-metallic core 12. Also located within recess 22 is cover 26. Cover 26 extends from end 18 to core outer edge 24. Metal layer 14 is deposited over cover 26 and core outer edge 24. Once metal layer 14 has been deposited, bolt 28 is threaded into end 18 to secure end 18 of reinforcing structure 16D to metal layer 14.

FIG. 3B shows the engagement of end 20 with metal layer 14. End 20 of reinforcing structure 16D includes threads for being received by a nut. End 20 extends through non-metallic core 12 into recess 22. In this embodiment, no cover is present between end 20 and core outer edge 24. Metal layer 14 is deposited over core outer edge 24. To prevent the deposition of metal layer 14 on the threads of end 20, end 20 is covered by a mask during metal deposition. The mask prevents the plating or deposition of metal layer 14 onto end 20. Once metal layer 14 has been deposited on core outer edge 24, the mask is removed from end 20, and washer 30 and nut 32 can be threaded onto end 20 to join end 20 with metal layer 14. Washer 30 can include features to grip into metal layer 14 to provide further transfer of structural loads.

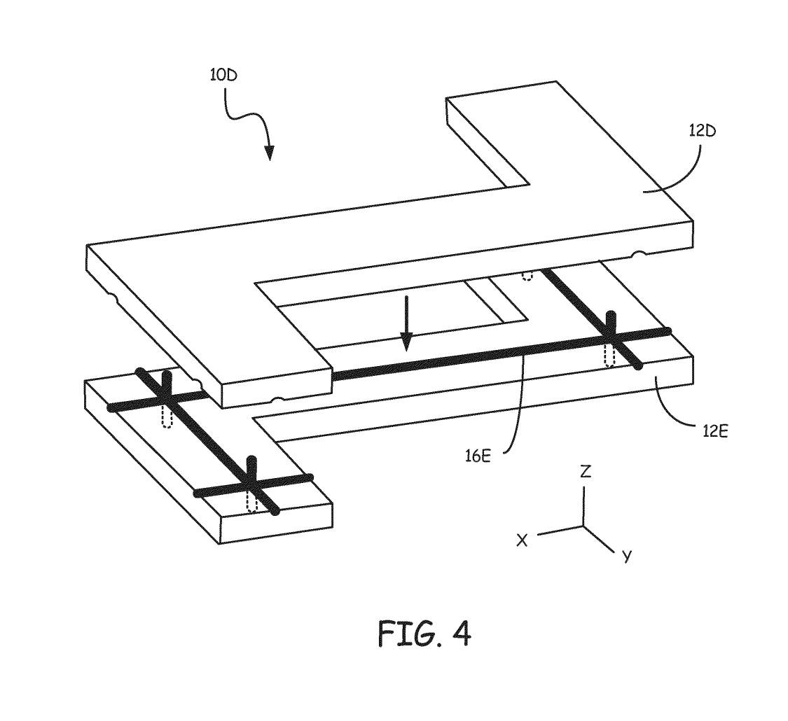

FIG. 4 illustrates an exploded view of another embodiment of a reinforced plated-polymeric component. Reinforced plated-polymeric component 10D includes non-metallic core layers 12D and 12E and reinforcing structure 16E. While plated-polymeric component 10B shown in FIG. 2 included a mesh network that extended in two dimensions (x and y), reinforcing structure 16E extends in three dimensions (x, y, and z). As described above and shown in FIGS. 3A and 3B, the ends of reinforcing structure 16E can join with metal layer 14 that is deposited over non-metallic core layers 12D and 12E. Ends in each of the three dimensions can be joined with metal layer 14

### DISCUSSION OF EMBODIMENTS

The following are non-exclusive descriptions of possible embodiments of the present invention.

A metal-plated component can include a non-metallic core having an outer surface, a metal layer covering at least a portion of the outer surface of the non-metallic core and a reinforcing structure located within the non-metallic core for increasing the structural capacity of the metal-plated component.

The metal-plated component of the preceding paragraph can optionally include, additionally and/or alternatively, any one or more of the following features, configurations, and/or additional components,

A further embodiment of the foregoing metal-plated component can further include that the non-metallic core is a material selected from the group consisting of polyether ether ketones, polyphenylene sulfides, polyesters, polyamides, polyetherimides, thermoplastic polyimides, polyether ketone ketones, polysulfones, any of the foregoing with fiber reinforcement and combinations thereof.

A further embodiment of the foregoing metal-plated component can further include that the non-metallic core is a material selected from the group consisting of condensation polyimides, addition polyimides, epoxy cured with aliphatic and/or aromatic amines and/or anhydrides, cyanate esters, phenolics, polyesters, polybenzoxazine, polyurethanes, polyacrylates, polymethacrylates, silicones (thermoset), any of the foregoing with fiber reinforcement and combinations thereof.

A further embodiment of any of the foregoing metal-plated components can further include that the non-metallic core is a composite material.

A further embodiment of any of the foregoing metal-plated components can further include that the reinforcing structure is a material selected from the group consisting of metals, alloys, intermetallics, ceramics, carbon-fiber composites, and combinations thereof

A further embodiment of any of the foregoing metal-plated components can further include that the reinforcing structure is spaced from the metal layer.

A further embodiment of any of the foregoing metal-plated components can further include that the reinforcing structure is joined to the metal layer.

A further embodiment of any of the foregoing metal-plated components can further include that the reinforcing structure is joined to the metal layer so that loads are transferred from the metal layer to the reinforcing structure.

A further embodiment of any of the foregoing metal-plated components can further include that a fastener selected from the group consisting of bolts, screws, and rivets joins the reinforcing structure to the metal layer.

A further embodiment of any of the foregoing metal-plated components can further include that the reinforcing structure is a plurality of rods or tubes.

A further embodiment of any of the foregoing metal-plated components can further include that the reinforcing structure is a hollow tube.

A further embodiment of any of the foregoing metal-plated components can further include that the non-metallic core has a plurality of layers and where the reinforcing structure is positioned between adjacent layers of the non-metallic core.

A further embodiment of any of the foregoing metal-plated components can further include that the reinforcing structure is a mesh.

A method for reinforcing a metal-plated component can include forming a non-metallic core, positioning a reinforcing structure within the non-metallic core, and depositing a metal layer on the non-metallic core.

The method of the preceding paragraph can optionally include, additionally, and/or alternatively, any one or more of the following features, configurations, and/or additional components.

A further embodiment of the foregoing method can further include that the reinforcing structure is spaced from the metal layer that is deposited on the non-metallic core.

A further embodiment of any of the foregoing methods can further include that the reinforcing structure is joined with the metal layer.

A further embodiment of any of the foregoing methods can further include attaching the reinforcing structure to the metal layer with a fastener.

A further embodiment of any of the foregoing methods can further include that depositing the metal layer on the non-metallic core occurs after the reinforcing structure is positioned within the non-metallic core.

A further embodiment of any of the foregoing methods can further include masking the reinforcing structure to prevent metal deposition on the reinforcing structure.

A further embodiment of any of the foregoing methods can further include that the reinforcing structure is positioned within the non-metallic core after depositing the metal layer on the non-metallic core.

Although the present invention has been described with reference to preferred embodiments, workers skilled in the art will recognize that changes may be made in form and detail without departing from the spirit and scope of the invention.

What is claimed is:

1. A metal-plated component comprising:
a non-metallic core having an outer surface;
a metal layer covering at least a portion of the outer surface of the non-metallic core; and
a reinforcing structure located within the non-metallic core for increasing the structural capacity of the metal-plated component.

2. The metal-plated component of claim 1, wherein the non-metallic core comprises a material selected from the group consisting of polyether ether ketones, polyphenylene sulfides, polyesters, polyamides, polyetherimides, thermoplastic polyimides, polyether ketone ketones, polysulfones, any of the foregoing with fiber reinforcement and combinations thereof.

3. The metal-plated component of claim 1, wherein the non-metallic core comprises a material selected from the group consisting of condensation polyimides, addition polyimides, epoxy cured with aliphatic and/or aromatic amines and/or anhydrides, cyanate esters, phenolics, polyesters, polybenzoxazine, polyurethanes, polyacrylates, polymethacrylates, silicones (thermoset), any of the foregoing with fiber reinforcement and combinations thereof.

4. The metal-plated component of claim 1, wherein the non-metallic core comprises a composite material.

5. The metal-plated component of claim 1, wherein the reinforcing structure comprises a material selected from the group consisting of metals, alloys, intermetallics, ceramics, carbon-fiber composites, and combinations thereof.

6. The metal-plated component of claim 1, wherein the reinforcing structure is spaced from the metal layer.

7. The metal-plated component of claim 1, wherein the reinforcing structure is joined to the metal layer.

8. The metal-plated component of claim 7, wherein the reinforcing structure is joined to the metal layer so that loads are transferred from the metal layer to the reinforcing structure.

9. The metal-plated component of claim 8, wherein a fastener selected from the group consisting of bolts, screws, and rivets joins the reinforcing structure to the metal layer.

10. The metal-plated component of claim 1, wherein the reinforcing structure comprises a plurality of rods or tubes.

11. The metal-plated component of claim 1, wherein the reinforcing structure comprises a hollow tube.

12. The metal-plated component of claim 1, wherein the non-metallic core comprises a plurality of layers, and wherein the reinforcing structure is positioned between adjacent layers of the non-metallic core.

13. The metal-plated component of claim 12, wherein the reinforcing structure comprises a mesh.

14. A method for reinforcing a metal-plated component, the method comprising:
forming a non-metallic core;
positioning a reinforcing structure within the non-metallic core; and
depositing a metal layer on the non-metallic core.

15. The method of claim 14, wherein the reinforcing structure is spaced from the metal layer that is deposited on the non-metallic core.

16. The method of claim 14, wherein the reinforcing structure is joined with the metal layer.

17. The method of claim 16, further comprising:
attaching the reinforcing structure to the metal layer with a fastener.

18. The method of claim 14, wherein depositing the metal layer on the non-metallic core occurs after the reinforcing structure is positioned within the non-metallic core.

19. The method of claim 18, further comprising:
masking the reinforcing structure to prevent metal deposition on the reinforcing structure.

20. The method of claim 14, wherein the reinforcing structure is positioned within the non-metallic core after depositing the metal layer on the non-metallic core.
